(19) United States
(12) Patent Application Publication
(10) Pub. No.: US 2026/0349861 A1
(43) Pub. Date: Nov. 5, 2026

(54) SYSTEM AND METHOD FOR DETECTING PERFORMANCE DEGRADATION IN DEPLOYED ARTIFICIAL INTELLIGENCE MODELS

(71) Applicant: AUTOMATION ANYWHERE, INC., San Jose, CA (US)

(72) Inventor: Aditya BHUWANIA, San Jose, CA (US)

(21) Appl. No.: 19/657,599

(22) Filed: Apr. 24, 2026

(51) Int. Cl. G06F 11/07

(52) U.S. Cl. CPC G06F 11/0751; G06F 11/0715

(57) ABSTRACT

A computer-implemented method for evaluating performance of a deployed artificial intelligence model to reduce latency in detecting model performance degradation. The method comprises obtaining output generated by the deployed artificial intelligence model during execution of automation tasks by bots and automated workflows; extracting evaluation factors from the obtained output, wherein the evaluation factors include compliance factors, quality factors, and responsible artificial intelligence parameters; scoring the obtained output using a domain-trained model to generate numerical scores representing output quality across each evaluation factor; generating a combined model score using a scoring module that aggregates the numerical scores by applying weighting factors corresponding to configured importance levels; generating a performance degradation signal when the combined model score falls below a threshold criterion, enabling automated detection of model performance degradation without manual evaluation; and transmitting a recommendation to transition to an alternative artificial intelligence model in response to the performance degradation signal.

### FIELD OF INVENTION

The present disclosure relates to artificial intelligence model evaluation and recommendation systems, and more particularly to indicating performance degradation of artificial intelligence model.

### BACKGROUND

Enterprise computing environments increasingly deploy large language models (LLMs) and automated bot systems to handle tasks across diverse verticals including finance, insurance, banking, and supply chain management. These deployments involve multiple LLM providers and model variants, each exhibiting different performance characteristics across dimensions such as inference latency, output quality, compliance adherence, and resource consumption. As organizations scale their AI-driven automation, they face challenges in systematically evaluating which models perform adequately for specific domain requirements and operational constraints.

Conventional model evaluation approaches rely on generic performance metrics such as accuracy scores, perplexity measurements, or throughput benchmarks. These metrics, while useful for general-purpose comparisons, fail to capture domain-specific qualitative factors that enterprises consider when selecting models for production deployment. For example, a financial services organization may prioritize compliance-related output characteristics, while a supply chain operation may weight factors related to responsible sourcing verification or environmental impact assessment. Existing evaluation frameworks lack configurable parameter engines that allow organizations to define and weight such domain-specific criteria according to their operational priorities.

Furthermore, the landscape of available LLM models evolves rapidly, with new model versions and providers entering the market at an accelerating pace. Organizations deploying these models in production environments face difficulties in determining when to transition from one model to another. Without systematic scoring mechanisms that aggregate performance across multiple qualitative dimensions, enterprises lack data-driven guidance for model lifecycle management decisions. This results in either premature adoption of newer models without adequate validation or prolonged use of underperforming models that no longer meet evolving business requirements. Additionally, existing systems suffer from high latency in detecting model performance degradation, which can result in extended periods of suboptimal automation performance before issues are identified and remediated.

Rating and feedback collection systems in existing deployments often operate in isolation from model selection pipelines. User feedback, such as thumbs-up or thumbs-down ratings on model outputs, accumulates in data stores without systematic aggregation into actionable model performance scores. The absence of continuous feedback loops that connect user ratings to model ranking and recommendation systems prevents organizations from leveraging operational experience to inform model selection decisions. Additionally, detecting performance drift in deployed models where output quality degrades over time due to data distribution shifts or model staleness remains a manual and reactive process in many existing systems.

The computational overhead associated with evaluating models across multiple qualitative parameters presents additional challenges. Naive approaches that invoke full LLM inference for every evaluation dimension consume substantial GPU or TPU resources and introduce latency into evaluation pipelines. Existing systems lack efficient architecture that combine lightweight specialized models for parameter-specific scoring with aggregation mechanisms that synthesize individual scores into composite rankings suitable for recommendation generation.

Therefore, systems and methods that address one or more of these challenges in model evaluation, scoring, and recommendation across domain-specific parameters while reducing latency in detecting model performance degradation are desired.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one implementation, the method for evaluating performance of a deployed artificial intelligence model to reduce latency in detecting model performance degradation is disclosed. The method comprises obtaining, by one or more processors, output generated by the deployed artificial intelligence model during execution of one or more automation tasks by bots and automated workflows. The method comprises evaluating, by the one or more processors, the output based on one or more predefined evaluation factors, wherein the evaluation factors comprise compliance factors indicating adherence to defined requirements, quality factors indicating effectiveness in completing the one or more automation tasks, and responsible artificial intelligence parameters indicating adherence to operational constraints. The evaluating comprises scoring, by the one or more processors, the obtained output using a domain-trained model to generate numerical scores representing output quality across each evaluation factor, wherein the domain-trained model processes the predefined evaluation factors to produce the numerical scores. The method comprises computing, by the one or more processors, a combined model score that aggregates the numerical scores across the evaluation factors by applying weighting factors corresponding to configured importance levels for each evaluation factor. The method comprises generating, by the one or more processors, a performance degradation signal for the deployed artificial intelligence model when the combined model score falls below a threshold criterion, wherein the performance degradation signal enables automated detection of the model performance degradation without manual evaluation, thereby reducing the latency in detecting the model performance degradation. The method comprises transmitting, by the one or more processors, a recommendation to transition to an alternative artificial intelligence model in response to the performance degradation signal.

In one implementation, a system for evaluating performance of a deployed artificial intelligence model to reduce latency in detecting model performance degradation is disclosed. The system comprises at least one memory storing one or more instructions and at least one processor, such that upon execution of the one or more instructions, the processor is configured to obtain output generated by the deployed artificial intelligence model during execution of one or more automation tasks by bots and automated workflows. The processor is configured to evaluate the output based on one or more predefined evaluation factors, wherein the evaluation factors comprise compliance factors indicating adherence to defined requirements, quality factors indicating effectiveness in completing the one or more automation tasks, and responsible artificial intelligence parameters indicating adherence to operational constraints. The evaluating comprises scoring the obtained output using a domain-trained model to generate numerical scores representing output quality across each evaluation factor, wherein the domain-trained model processes the predefined evaluation factors to produce the numerical scores. The processor is configured to compute a combined model score that aggregates the numerical scores across the evaluation factors by applying weighting factors corresponding to configured importance levels for each evaluation factor. The processor is configured to generate a performance degradation signal for the deployed artificial intelligence model when the combined model score falls below a threshold criterion, wherein the performance degradation signal enables automated detection of the model performance degradation without manual evaluation, thereby reducing the latency in detecting the model performance degradation. The processor is configured to transmit a recommendation to transition to an alternative artificial intelligence model in response to the performance degradation signal.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system for evaluating performance of a deployed artificial intelligence model, in accordance with various embodiments of the present subject matter.

FIG. 2 illustrates a method for evaluating performance of a deployed artificial intelligence model, in accordance with various embodiments of the present subject matter.

FIG. 3 illustrates a system architecture for evaluating performance of a deployed artificial intelligence model, in accordance with various embodiments of the present subject matter.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to AI model evaluation and recommendation systems for enterprise computing environments. In some cases, such systems may be deployed within organizations that utilize multiple large language models (LLMs) across various verticals including finance, insurance, banking, and supply chain management. The systems and methods described herein may reduce latency in detecting model performance degradation by enabling automated detection of performance degradation without manual evaluation.

In an embodiment, a system and method are described for evaluating performance of deployed artificial intelligence models to reduce latency in detecting model performance degradation within enterprise computing environments. At a high level, the system operates by continuously monitoring outputs generated by deployed AI models during execution of automation tasks, evaluating the output based on predefined evaluation factors by scoring the outputs against domain-specific criteria, aggregating the scores into combined model scores, and generating performance degradation signals when scores fall below threshold criteria. The system then transmits recommendations to transition to alternative AI models in response to detected performance degradation. This automated approach eliminates the need for manual evaluation processes that introduce delays in identifying underperforming models, thereby enabling organizations to maintain optimal automation performance through timely model transitions.

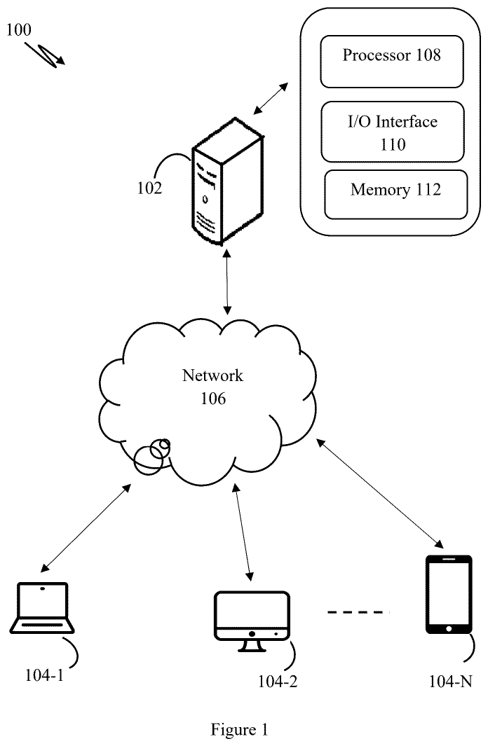

Referring to FIG. 1 now, a network implementation 100 for evaluating performance of a deployed artificial intelligence model to reduce latency in detecting model performance degradation. The network 100 includes a system 102, one or more user devices 104-N (for example but not limited to one or more user devices 104-1, 104-2 . . . 104-N) associated with one or more users. The user devices 104-N comprise end user mobile devices such as smartphones, tablets, or other mobile computing devices owned and operated by end users. In an embodiment, a software application may be installed at the user device 104 and the user device 104 may interact with the software application to transmit and receive data from and to the system 102. In an embodiment the user device 104 may be a registered user device to access the system 102.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, a cloud-based computing environment. In one implementation, the system 102 may comprise the cloud-based computing environment in which the data storage device may operate individual computing systems configured to execute remotely located applications. Further, the system 102 and the user device 104 may communicate through the network 106. Examples of the user devices 104 may include, but are not limited to, a portable computer, a personal digital assistant, a handheld device, and a workstation. In an embodiment, the user device may transmit captured data via wireless network 106, to the system 102.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 may include at least one processor 108, an input/output (I/O) interface 110, a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the client devices 104. Further, the I/O interface 110 may enable the system 102 to communicate with other computing devices, such as web servers, device 104, and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions. In an embodiment, the device 104 may include a processor, I/O Interface, and Memory for execution of inputs received by device 104.

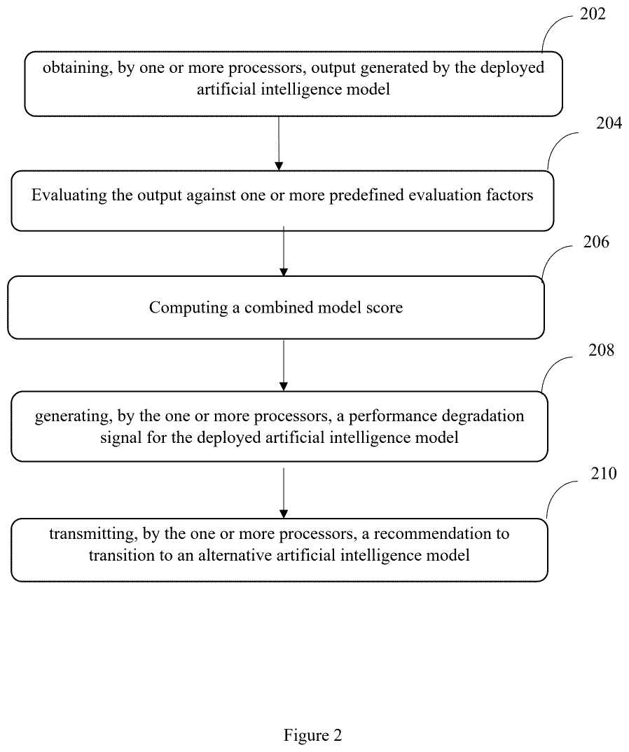

Referring now to FIG. 2, a method 200 for evaluating performance of a deployed artificial intelligence model to reduce latency in detecting model performance degradation, in accordance with one or more embodiments of the present subject matter, is disclosed. The method 200 may be described in the general context of computer executable instructions. Generally, computer executable instructions can include routines, programs, objects, components, data structures, procedures, modules, functions, etc., that perform particular functions or implement particular abstract data types. The method 200 for evaluating performance of a deployed artificial intelligence model may be implemented in any suitable hardware, software, firmware, or combination thereof. However, for ease of explanation, in the embodiments described below, the method 200 may be considered to be implemented in the system 102 of FIG. 1 by the processor(s) 108 in association with the other devices in the network 100.

In an embodiment, at step 202, the system 102 is configured to obtain output generated by deployed artificial intelligence models during execution of one or more automation tasks by one or more bots and automated workflows. The system may implement output collection through integration with bot execution environments and workflow orchestration platforms operating within the enterprise computing environment. In some cases, the system may intercept model outputs at inference endpoints where bots and workflows invoke deployed AI models to generate responses, extract information, or perform decision-making operations. The system may capture output data including generated text, extracted entities, classification results, and any other artifacts produced by the deployed AI models during task execution.

In an example, the obtained outputs may be associated with metadata identifying the specific AI model that generated the output, the bot or workflow context in which the output was generated, timestamps indicating when generation occurred, and identifiers for the automation task being performed. In an embodiment, the system may store obtained outputs in a data repository that supports subsequent extraction and scoring operations. The output collection mechanism may operate continuously during bot and workflow execution to ensure comprehensive capture of model outputs across all automation tasks performed within the enterprise environment.

In an embodiment, the bots and automated workflows that generate these outputs perform various domain-specific tasks. In an embodiment, bots may refer to software agents configured to execute predefined tasks within enterprise computing environments. Bots may interact with enterprise applications, process documents, extract data, and perform repetitive operations according to programmed instructions. In some cases, bots may be associated with specific business verticals and may be configured to handle domain-specific tasks such as invoice processing, report generation, or data reconciliation. In an embodiment, automated workflows refer to sequences of operations that execute in response to triggering conditions without requiring manual intervention. Automated workflows may orchestrate multiple bots, may route data between enterprise systems, and may implement business logic for processing transactions or handling exceptions. In some cases, automated workflows may be generated dynamically based on detected conditions or user requests.

In an embodiment, the system is configured to continuously monitor the outputs generated by the deployed artificial intelligence model during execution of automation tasks. The continuous monitoring enables real-time capture of model outputs as they are generated, supporting the technical effect of reducing latency in detecting model performance degradation. The system implements continuous monitoring through integration with bot execution environments and workflow orchestration platforms operating within the enterprise computing environment. The monitoring mechanism operates as an always-on process that intercepts and captures model outputs without interrupting the normal execution flow of automation tasks. In an embodiment, the system may deploy monitoring agents within the bot execution environment that observe inference requests and responses exchanged between bots and deployed AI models. The monitoring agents may operate as middleware components positioned between the automation layer and the model inference layer, enabling transparent capture of all model interactions.

In an embodiment, at step 204, the system is configured to evaluate, by the one or more processors, the output from the deployed artificial intelligence model based on one or more evaluation factors, which may be predefined. In an embodiment, the evaluation factors comprise compliance factors indicating adherence to defined requirements, quality factors indicating effectiveness in completing the one or more automation tasks, and responsible artificial intelligence parameters indicating adherence to operational constraints. For example, the system may implement extraction through analysis modules that parse obtained outputs and identify characteristics relevant to each evaluation factor category. The extraction process analyses the content and characteristics of outputs generated by the deployed AI model to identify measurable attributes that correspond to each category of evaluation factor.

In an embodiment, compliance factors may include indicators of regulatory adherence, policy conformance, data handling compliance, and audit trail completeness that the system extracts by analyzing output content against defined compliance criteria. In some cases, compliance factors may indicate whether the AI model's outputs conform to organizational policies, industry standards, or operational rules that govern how automation tasks should be performed. The system may compare output characteristics against predefined compliance criteria to determine the degree to which outputs satisfy compliance requirements. In an embodiment, Quality factors may include indicators of output accuracy, completeness, relevance, coherence, and task completion effectiveness that the system extracts by comparing outputs against expected results or quality benchmarks. In some cases, quality factors may indicate whether the AI model successfully completed the automation task as intended, whether the output contains all required information, and whether the output is suitable for downstream processing or consumption. The system may evaluate outputs against golden test data sets or expected output specifications to assess quality factor values.

In an embodiment, responsible AI parameters may include indicators of bias avoidance, fairness, transparency, explainability, and ethical constraint adherence that the system extracts by analyzing outputs for characteristics that may indicate responsible AI concerns. In some cases, responsible AI parameters may indicate whether the AI model's outputs exhibit patterns that could suggest biased decision-making, whether outputs provide sufficient transparency regarding how conclusions were reached, and whether outputs adhere to ethical guidelines established by the organization.

In an embodiment, the one or more evaluation factors may include attributes related to environmental sustainability, ethical sourcing practices, organizational diversity metrics, and industry-specific regulatory considerations. Green supply chain management attributes may constitute a category of niche business attributes that organizations configure as evaluation factors. Green supply chain management attributes may include environmental impact assessment that measures whether AI model outputs appropriately consider environmental factors such as carbon footprint considerations, emissions reduction opportunities, or sustainable material alternatives. Green supply chain management attributes may also include sustainable sourcing verification that measures whether AI model outputs verify or prioritize suppliers that adhere to sustainable sourcing practices, including environmental certifications and renewable energy usage. Additional green supply chain management attributes may include circular economy alignment that measures whether AI model outputs support circular economy principles such as material reuse, recycling optimization, and product lifecycle extension.

In an embodiment, the system enables users to define the one or more evaluation factors. The user may define and transit these factors using user device 104. When a user defines a new evaluation factor, the user specifies the factor name, a description of what the factor measures, scoring criteria that describe how outputs should be assessed against the factor, and an importance level indicating the weight of the factor in combined model score calculations. The system 102 receives the customer-defined evaluation factor through the configuration interface and validates that the factor definition includes all required components. Upon successful validation, the system stores the customer-defined evaluation factor in a configuration repository in association with the customer's organizational profile. The configuration repository maintains a structured record for each evaluation factor that includes the factor identifier, factor name, description, scoring criteria, importance level, creation timestamp, and customer organization identifier. The system may store evaluation factors in a database that supports efficient retrieval operations, enabling rapid access to factor definitions during evaluation processing. In an example, when an evaluation is needed to be performed, the system retrieves the customer-defined evaluation factors from the configuration repository by querying for all active evaluation factors associated with the customer's organizational profile. The system fetches the factor definitions including scoring criteria and importance levels, and loads the retrieved factors into the evaluation pipeline. The domain-trained model receives the retrieved evaluation factor definitions as context that informs scoring decisions, enabling the model to assess outputs against the customer-specific criteria. The scoring module retrieves the importance levels for each evaluation factor and applies the corresponding weighting factors when aggregating numerical scores into the combined model score. This retrieval mechanism ensures that each evaluation operation applies the customer's current factor configurations, enabling organizations to modify evaluation criteria without requiring system reconfiguration or model retraining.

In an embodiment, in order to evaluate the outputs against the evaluation factors the system is configured to score the obtained output using a domain-trained model to generate numerical scores representing output quality across each evaluation factor. For example, the system may implement scoring through specialized models that have been trained on domain-specific data to assess output quality within particular business verticals or operational contexts (evaluation factors). The domain-trained model refers to a machine learning model that has been configured or trained to understand the specific characteristics, terminology, and quality criteria relevant to a particular operational domain.

In an embodiment, the domain-trained models may receive evaluation factor records as inputs and may produce score values within defined ranges, such as scores from zero to one hundred, that quantify output quality for each factor. The evaluation factor records comprise the compliance factors, quality factors, green supply chain management factors, and responsible AI parameters that were extracted in the previous step. The domain-trained models may apply learned patterns to assess whether factor values indicate high-quality outputs, acceptable outputs, or deficient outputs, and may assign corresponding score values. The model analyzes each evaluation factor and determines a numerical score based on how well the output meets the criteria for that factor.

The scoring may invoke different domain-trained models for different business verticals to account for vertical-specific quality criteria, where a domain-trained model configured for finance verticals may apply scoring criteria emphasizing numerical accuracy and regulatory compliance, while a domain-trained model configured for supply chain verticals may apply scoring criteria emphasizing data timeliness and logistics coordination effectiveness. In an example, the domain-trained model may be trained using Retrieval Augmented Generation (RAG) Approach: For example, the system may train the domain-trained model using Retrieval Augmented Generation (RAG) on robotic process automation-specific entities. The robotic process automation-specific entities may include enterprise application identifiers, bot name registries, action type definitions, trigger type specifications, and credential reference patterns. Training the domain-trained model using RAG may comprise constructing a knowledge base containing definitions and operational characteristics of the robotic process automation-specific entities, retrieving relevant entity definitions from the knowledge base based on entities identified within an evaluation request context, and incorporating the retrieved entity definitions into a prompt provided to the domain-trained model to augment context with domain-specific information that informs scoring decisions. The RAG-based training approach may enable the domain-trained model to access RPA-specific entity information during inference without requiring modification of underlying model weights, and may enable rapid incorporation of new RPA-specific entities into the knowledge base through database operations rather than requiring model retraining cycles.

For example, the knowledge base may contain an entry for the SAP enterprise application that includes:
Canonical name: “SAP”
Aliases: “SAP ERP,” “SAP S/4HANA,” “SAP ECC”
Operational characteristics: Financial transaction processing, material management, human resources management
Compliance requirements: Audit field requirements, data retention policies, segregation of duties constraints
Quality benchmarks: Expected extraction accuracy thresholds for invoice processing, report generation latency targets

### Step 2: Retrieving Relevant Entity Definitions

When the system receives an evaluation request containing outputs from a deployed AI model, the system identifies entities within the evaluation request context. The system then queries the knowledge base to retrieve relevant entity definitions based on the identified entities.

The retrieval process may operate as follows:
1. Entity identification: The system parses the evaluation request context to identify references to RPA-specific entities, including enterprise applications, bot names, action types, trigger types, and credentials
2. Query formulation: The system formulates queries against the knowledge base based on the identified entities
3. Definition retrieval: The system retrieves entity definitions from the knowledge base that match the formulated queries, including operational characteristics, quality criteria, and scoring guidelines
4. Context assembly: The system assembles the retrieved definitions into a structured context representation that can be incorporated into the scoring prompt

For example, if the output being evaluated relates to an SAP invoice processing task performed by an Invoice Extractor bot, the system retrieves:
SAP enterprise application definition and compliance requirements
Invoice Extractor bot specifications and quality benchmarks
Data extraction action type definitions and scoring criteria
Credential patterns for SAP authentication
   Step 3: Incorporating Retrieved Definitions into Prompts

The system incorporates the retrieved entity definitions into a prompt provided to the domain-trained model to augment context with domain-specific information that informs scoring decisions. The augmented prompt contains:
Original evaluation factors: The compliance factors, quality factors, and responsible AI parameters extracted from the obtained output
Retrieved entity definitions: RPA-specific entity definitions that provide domain context relevant to the evaluation
Quality criteria: Scoring guidelines and benchmarks specific to the identified entities
Scoring instructions: Directives that guide the domain-trained model to apply the retrieved criteria when generating numerical scores

The domain-trained model processes the augmented prompt and generates numerical scores informed by the domain-specific information retrieved from the knowledge base. The RAG-based training approach may enable the domain-trained model to access RPA-specific entity information during inference without requiring modification of underlying model weights, and may enable rapid incorporation of new RPA-specific entities into the knowledge base through database operations rather than requiring model retraining cycles. [9]

### Example: Scoring an Invoice Processing Output Using RAG

Consider a scenario where the system scores outputs from a deployed AI model used for SAP invoice processing:

### 1. Evaluation Request Context:

The system receives extracted evaluation factors from an invoice processing output, including:
Compliance factors: Audit field presence, data handling compliance indicators
Quality factors: Extraction accuracy metrics, completeness indicators
Responsible AI parameters: Confidence level transparency, bias indicators

### 2. Entity Identification:

The system identifies the following RPA-specific entities in the evaluation context:
Enterprise application: SAP
Bot name: Invoice Extractor
Action types: Data extraction, field validation
Credentials: SAP service account

### 3. Knowledge Base Retrieval:

The system queries the knowledge base and retrieves:
SAP compliance requirements (audit field requirements specifying that invoice number, vendor ID, and approval timestamp must be captured; data retention policies requiring seven-year retention)
Invoice Extractor bot quality benchmarks (expected extraction accuracy of 95% for structured fields, 85% for unstructured fields)
Data extraction action type scoring criteria (completeness metrics requiring all mandatory fields, format validation rules for currency and date fields)
SAP credential patterns (service account authentication requirements, session management constraints)

### 4. Prompt Augmentation:

The system constructs an augmented prompt containing:

### Evaluation Context:

Output Type: Invoice data extraction from SAP
Bot: Invoice Extractor
Enterprise Application: SAP

### Extracted Evaluation Factors:

Compliance: Audit fields present (invoice number: yes, vendor ID: yes, approval timestamp: missing)
Quality: Extraction accuracy 92%, completeness 88%
Responsible AI: Confidence levels reported, no bias indicators detected

### Retrieved Domain Criteria:

SAP Compliance Requirements: Audit fields must include invoice number, vendor ID, and approval timestamp
Invoice Extractor Quality Benchmarks: Target accuracy 95% for structured fields
Scoring Guidelines: Deduct points for missing audit fields; apply accuracy threshold comparison. Generate numerical scores (0-100) for each evaluation factor based on the above criteria.

The domain-trained model processes the augmented prompt and generates numerical scores:
Compliance factor score: 78 (audit fields partially present but approval timestamp missing)
Quality factor score: 89 (extraction accuracy 92% approaches but does not meet 95% target)
Responsible AI parameter score: 92 (confidence levels reported, no bias indicators)

These numerical scores then flow to the scoring module for aggregation into the combined model score using configured weighting factors. The system may implement the threshold criterion as a percentage threshold, wherein the method further comprises computing the combined model score as a percentage value representing model performance relative to a defined benchmark, and generating the performance degradation signal when the percentage value falls below the percentage threshold. The percentage threshold represents a configurable boundary expressed as a percentage value that separates acceptable model performance from degraded performance. Organizations may configure percentage thresholds based on their operational requirements and tolerance for performance variation.

For example, an organization may configure a percentage threshold of 75%, meaning that any deployed AI model achieving a combined model score below 75% of the defined benchmark will trigger a performance degradation signal. The system computes the combined model score as a percentage value representing model performance relative to a defined benchmark. The computation process involves: Step 1: Establishing the Defined Benchmark: The defined benchmark represents a reference point against which model performance is measured. In some cases, the benchmark may be: A theoretical maximum score (e.g., 100 points) representing ideal performance across all evaluation factors, A historical baseline score representing the model's performance during an initial evaluation period, An industry standard score representing expected performance levels for models in a particular domain, A competitor model score representing the performance of alternative models available in the market. Step 2: Computing the Raw Combined Score

The system aggregates the numerical scores across the evaluation factors by applying weighting factors corresponding to configured importance levels for each evaluation factor, as described in the scoring module operation. This produces a raw combined score value. Step 3: Converting to Percentage Value. The system converts the raw combined score to a percentage value by dividing the raw combined score by the defined benchmark and multiplying by 100. For example: Raw combined score: 72 points, Defined benchmark: 100 points (theoretical maximum), Percentage value: (72/100)×100=72%, Generating the Performance Degradation Signal.

The system generates the performance degradation signal when the percentage value falls below the percentage threshold. The comparison operation evaluates whether the computed percentage value is less than the configured percentage threshold. When the percentage value falls below the threshold, the system automatically generates the performance degradation signal without requiring manual evaluation.

In another embodiment, the system may support fine-tuning of existing open source models by taking model weights from pre-trained models and training on domain-specific data. Fine-tuning may involve collecting datasets containing RPA-specific examples, including user requests paired with corresponding bot actions, workflow definitions, and disambiguation patterns. The fine-tuning process may adjust model weights to improve performance on RPA-specific tasks while preserving general language understanding capabilities acquired during pre-training.

In an embodiment, the selection between RAG and fine-tuning may depend on multiple factors including cost constraints, update frequency requirements, and organizational infrastructure capabilities. Organizations with limited computational budgets may select RAG-based training due to lower infrastructure requirements. Organizations requiring frequent updates to domain knowledge, such as weekly additions of new bot definitions, may select RAG-based training to avoid repeated fine-tuning cycles. Organizations with stable domain knowledge that changes infrequently may select fine-tuning to achieve lower inference latency and reduced dependency on external retrieval systems. In some cases, organizations may employ hybrid approaches that combine RAG-based retrieval with fine-tuned models, using fine-tuning to embed foundational RPA concepts while using RAG to incorporate frequently changing operational details.

Consider a scenario where a deployed AI model generates output during an invoice processing automation task. The system would process this as follows: The system obtains invoice data including vendor name, invoice number, line items, amounts, and payment terms from a scanned invoice document. 2. Evaluation Factors: Compliance factors: Whether obtained data includes required audit fields, whether sensitive data is properly handled. Quality factors: Accuracy of obtained amounts, completeness of line-item capture, correct identification of vendor information. Responsible AI parameters: Whether the extraction process avoided bias in vendor categorization, whether confidence levels are transparently reported 3. Domain-Trained Model Processing: The domain-trained model configured for finance verticals receives the evaluation factor records. The model applies learned patterns from training on finance-specific datasets to assess: Whether numerical amounts match expected formats and validation rules (scoring numerical accuracy). Whether all required compliance fields are present and correctly populated (scoring regulatory compliance). Whether extraction confidence meets acceptable thresholds (scoring quality) 4. Numerical Score Generation: The domain-trained model produces scores such as: Compliance factor score: 85 out of 100 (audit fields present but one optional field missing). Quality factor score: 92 out of 100 (high accuracy on amounts, one line item partially extracted). Responsible AI parameter score: 88 out of 100 (confidence levels reported, no bias indicators detected) These numerical scores then flow to the subsequent aggregation step where the scoring module combines them using configured weighting factors to produce the combined model score.

In an embodiment, the system, at step 206 is configured to compute a combined model score using a scoring module that aggregates the numerical scores across the evaluation factors by applying weighting factors corresponding to configured importance levels for each evaluation factor. For example, the scoring module may receive individual factor scores produced by the domain-trained models and may synthesize the individual scores into aggregate assessments that characterize overall model performance. The combined model score represents a single numerical value that consolidates the performance of the deployed AI model across all evaluation dimensions into one comprehensive metric. This aggregated score enables straightforward comparison against threshold criteria and simplifies the determination of whether performance degradation has occurred.

In an embodiment, the weighting factors may correspond to importance levels specified through customer configuration interfaces, where customers assign higher weights to evaluation dimensions that align with organizational priorities. The scoring module may multiply each individual factor score by the corresponding weight and may compute weighted sums that represent aggregate performance assessments. The weighting mechanism ensures that evaluation factors deemed more important by the organization have greater influence on the combined model score than factors of lesser importance. In some cases, the system may configure the importance levels for the evaluation factors using slider interfaces that enable specification of importance levels from one to ten for each evaluation factor. The evaluation factors may include output consistency, governance, compliance, and cost. When a customer adjusts a slider to set an importance level for an evaluation factor, the system may store the configured importance level in association with the customer's organizational profile and may use the configured importance levels to weight evaluation scores when generating aggregate model rankings.

In an embodiment, the scoring module may analyze patterns across individual factor scores to identify models that exhibit consistent performance across evaluation dimensions versus models that exhibit uneven performance with strengths in some dimensions and weaknesses in others. This pattern analysis capability enables the system to provide additional insights beyond the single combined score, helping organizations understand whether a model performs uniformly or has significant variations across different evaluation criteria.

### Example 1: Financial Services Organization

Consider a financial services organization that prioritizes compliance above other factors. The organization configures the following importance levels:

| Evaluation | Importance | Normalized |
|---|---|---|
| Factor | Level (1-10) | Weight |
| Compliance | 10 | 0.40 |
| factors | | |
| Quality factors | 7 | 0.28 |
| ResponsibleAI | 5 | 0.20 |
| parameters | | |
| Cost efficiency | 3 | 0.12 |

The domain-trained model produces the following numerical scores for a deployed AI model:

| Evaluation Factor | Numerical Score (0-100) |
|---|---|
| Compliance factors | 92 |
| Quality factors | 85 |
| Responsible AI parameters | 78 |
| Cost efficiency | 70 |

The scoring module computes the combined model score as follows:

Combined Score=(92×0.40)+(85×0.28)+(78×0.20)+(70×0.12)

Combined Score=36.8+23.8+15.6+8.4

Combined Score=84.6

Because the organization weighted compliance heavily and the model scored well on compliance (92), the combined score (84.6) reflects this strength despite lower scores in other areas.

### Example 2: Supply Chain Organization

Consider a supply chain organization that values quality and responsible AI practices more equally. The organization configures the following importance levels:

| Evaluation | Importance | Normalized |
|---|---|---|
| Factor | Level (1-10) | Weight |
| Compliance factors | 5 | 0.20 |
| Quality factors | 8 | 0.32 |
| ResponsibleAI | 8 | 0.32 |
| parameters | | |
| Cost efficiency | 4 | 0.16 |

Using the same numerical scores from the domain-trained model:

| Evaluation Factor | Numerical Score (0-100) |
|---|---|
| Compliance factors | 92 |
| Quality factors | 85 |
| Responsible AI parameters | 78 |
| Cost efficiency | 70 |

The scoring module computes the combined model score as follows:

Combined Score=(92×0.20)+(85×0.32)+(78×0.32)+(70×0.16)

Combined Score=18.4+27.2+24.96+11.2

Combined Score=81.76

Despite identical numerical scores from the domain-trained model, the different weighting configuration produces a lower combined score (81.76 versus 84.6) because this organization places less emphasis on compliance where the model excels and more emphasis on responsible AI parameters where the model scores lower.

In an embodiment, the system, at step 208, is configured to generate a performance degradation signal for the deployed artificial intelligence model when the combined model score falls below a threshold criterion. The performance degradation signal enables automated detection of model performance degradation without manual evaluation, thereby reducing the latency in detecting the model performance degradation. For example, the performance degradation signal represents an automated notification or indicator that the system generates when it determines that a deployed AI model's performance has declined below acceptable levels. In some cases, the threshold criterion may comprise a percentage threshold, and the system may compute the combined model score as a percentage value representing model performance relative to a defined benchmark and may generate the performance degradation signal when the percentage value falls below the percentage threshold. The automated generation of performance degradation signals eliminates delays associated with manual review processes and enables immediate identification of models requiring attention or replacement.

In an embodiment, the threshold criterion represents a configurable boundary that separates acceptable model performance from degraded performance. Organizations may configure threshold criteria based on their operational requirements and tolerance for performance variation. In some cases, the threshold criterion may be an absolute value, such as a combined model score of 80 out of 100, below which the system generates a performance degradation signal. In other cases, the threshold criterion may be a relative value that compares current performance against historical baselines.

### Example 3: Threshold Comparison and Performance Degradation Detection

Continuing with the financial services organization example, assume the organization has configured a threshold criterion of 80 for acceptable model performance.
Evaluation Period 1: Combined model score: 84.6
Threshold criterion: 80
Result: Score exceeds threshold; no performance degradation signal generated
Evaluation Period 2 (after model drift occurs):
The domain-trained model produces updated numerical scores:
Evaluation Factor Numerical Score (0-100)
Compliance factors 75
Quality factors 72
Responsible AI parameters 70
Cost efficiency 68

Combined Score=(75×0.40)+(72×0.28)+(70×0.20)+(68×0.12)

Combined Score=30.0+20.16+14.0+8.16

Combined Score=72.32
Combined model score: 72.32
Threshold criterion: 80
Result: Score falls below threshold; performance degradation signal generated

The performance degradation signal enables automated detection of model performance degradation without manual evaluation, thereby reducing the latency in detecting model performance degradation. The automated generation of performance degradation signals eliminates delays associated with manual review processes and enables immediate identification of models requiring attention or replacement. The combined model score serves as the basis for performance degradation detection and recommendation generation.

In an embodiment, the system may detect performance degradation by comparing the combined model score against one or more prior combined model scores from prior evaluation periods to detect a declining performance trend. The system may generate the performance degradation signal when a difference between the combined model score and the one or more prior combined model scores exceeds a configurable drift threshold. Detecting the declining performance trend may comprise computing confidence intervals around historical combined model scores and classifying a performance change as model drift when the combined model score falls outside the computed confidence intervals. The drift detection capability enables the system to identify gradual performance degradation that may not trigger absolute threshold violations but nonetheless indicates declining model quality over time.

The system operates by continuously monitoring outputs generated by deployed AI models during execution of automation tasks, extracting evaluation factors from those outputs, scoring the outputs against domain-specific criteria, aggregating the scores into combined model scores, and generating performance degradation signals when scores fall below threshold criteria. This automated approach eliminates the need for manual evaluation processes that introduce delays in identifying underperforming models, thereby enabling organizations to maintain optimal automation performance through timely model transitions.

Consider a deployed AI model used for invoice processing automation. The organization has configured a threshold criterion of 75 for acceptable model performance.

### Evaluation Period 1:

Combined model score: 88
Threshold criterion: 75
Result: Score exceeds threshold; no performance degradation signal generated; model continues operating normally

### Evaluation Period 2:

Combined model score: 82
Threshold criterion: 75
Result: Score exceeds threshold; no performance degradation signal generated; system notes slight decline but within acceptable range
   Evaluation Period 3 (after Data Distribution Shift):
Combined model score: 71
Threshold criterion: 75
Result: Score falls below threshold; performance degradation signal generated automatically

The system generates the performance degradation signal immediately upon detecting that the combined model score (71) has fallen below the threshold criterion (75), without requiring any manual review or human intervention.

### Example: Drift-Based Degradation Detection

Consider the same deployed AI model, but now the organization has also configured drift detection with a drift threshold of 10 points.

| Evaluation | Combined | Change from |
|---|---|---|
| Period | Model Score | Prior Period |
| Period 1 | 88 | — |
| Period 2 | 85 | −3 |
| Period 3 | 82 | −3 |
| Period 4 | 79 | −3 |
| Period 5 | 76 | −3 |

Although the combined model score in Period 5 (76) still exceeds the absolute threshold criterion of 75, the system detects a declining performance trend. The cumulative decline from Period 1 to Period 5 is 12 points (88 to 76), which exceeds the configured drift threshold of 10 points. The system generates a performance degradation signal based on the detected drift, even though the absolute threshold has not been violated. This enables proactive identification of gradual degradation before performance declines to unacceptable levels.

In an embodiment, the system, at 210, is configured to transmit a recommendation to transition to an alternative artificial intelligence model in response to the performance degradation signal. The recommendation to transition to the alternative artificial intelligence model may include an identifier of the alternative artificial intelligence model and a performance comparison indicating that the alternative artificial intelligence model achieves a higher combined model score than the deployed artificial intelligence model. The system may identify candidate replacement models by querying a model performance repository for models that achieve higher performance scores than the degrading model across the evaluation criteria where degradation was detected. The recommendations may include supporting evidence derived from the scoring processes, such as aggregate score values, factor-specific score comparisons, and trend indicators showing performance trajectories.

The system identifies alternative models by analyzing the model performance repository to find models that demonstrate superior performance on the evaluation factors where the deployed model exhibited degradation. In an embodiment, the system may prioritize candidate models that excel in the specific evaluation factors where the deployed model scored lowest. For example, if the deployed model's degradation was primarily driven by declining compliance factor scores, the system may identify alternative models that achieve high compliance factor scores.

The system transmits the recommendation through configured notification channels, which may include: Dashboard alerts within the control room interface, Email notifications to designated administrators, API callbacks to external monitoring systems, Integration with incident management platforms.

### Example: Complete Degradation Detection and Recommendation Flow

Consider an organization using a deployed AI model for customer service automation. The evaluation process proceeds as follows:

### Step 1: Obtain Output

The system obtains outputs generated by the deployed AI model during execution of customer inquiry handling tasks.

### Step 2: Extract Evaluation Factors

The system obtains evaluation factors and the outputs:
Compliance factors: Response adherence to regulatory disclosure requirements
Quality factors: Accuracy and completeness of responses to customer inquiries
Responsible AI parameters: Absence of biased language or unfair treatment patterns
   Step 3: Score Using Domain-Trained Model The domain-trained model generates numerical scores:
Compliance factor score: 72
Quality factor score: 68
Responsible AI parameter score: 75

### Step 4: Generate Combined Model Score

The scoring module applies configured weighting factors (compliance: 0.40, quality: 0.35, responsible AI: 0.25):

Combined Score=(72×0.40)+(68× 0.35)+(75× 0.25)

Combined Score=28.8+23.8+18.75

Combined Score=71.35

### Step 5: Generate Performance Degradation Signal

The system compares the combined model score (71.35) against the threshold criterion (75). Because the score falls below the threshold, the system generates a performance degradation signal.

### Step 6: Transmit Recommendation

The system queries the model performance repository and identifies an alternative AI model that achieves a combined model score of 84. The system transmits a recommendation containing:
Identifier of the alternative model
Performance comparison showing the alternative model scores 84 versus the deployed model's 71.35
Factor-specific comparison showing the alternative model's scores: compliance (85), quality (82), responsible AI (86)
Trend indicator showing the deployed model's score has declined from 82 to 71.35 over the past three evaluation periods. The recommendation enables the organization to make an informed decision about transitioning to the alternative model, supported by quantitative evidence from the automated evaluation process.

### Example: Percentage-Based Performance Degradation Detection

Consider a deployed AI model used for document classification automation. The organization has configured the following: Defined benchmark: 100 points (theoretical maximum), Percentage threshold: 80, Evaluation Period 1: The domain-trained model produces the following numerical scores: Evaluation Factor Numerical Score WeightWeighted Score
Compliance factors 90 0.35 31.5
Quality factors88 0.40 35.2
Responsible AI parameters 85 0.25 21.25
Raw combined score: 31.5+35.2+21.25=87.95 points
Percentage value: (87.95/100)×100=87.95%
Comparison: 87.95%>80% (percentage threshold)
Result: No performance degradation signal generated; model continues operating normally
Evaluation Period 2: The domain-trained model produces the following numerical scores after data distribution shift: Evaluation Factor Numerical Score Weight Weighted Score
Compliance factors 78 0.35 27.3
Quality factors 72 0.40 28.8
Responsible AI parameters 70 0.25 17.5
Raw combined score: 27.3+28.8+17.5=73.6 points
Percentage value: (73.6/100)×100=73.6%
Comparison: 73.6%<80% (percentage threshold)

Result: Performance degradation signal generated automatically

Example: Percentage Threshold with Historical Baseline Benchmark. Consider an alternative configuration where the defined benchmark is based on historical performance rather than a theoretical maximum: Defined benchmark: 92 points (model's average score during first month of deployment), Percentage threshold: 85%, Current Evaluation: Raw combined score: 73.6 points

Percentage value: (73.6/92)×100=80%, Comparison: 80%<85% (percentage threshold).

Result: Performance degradation signal generated

In this configuration, the model's current performance (73.6 points) represents only 80% of its historical baseline performance (92 points), which falls below the 85% threshold. This approach detects degradation relative to the model's own historical performance rather than an absolute standard. The percentage-based threshold approach provides several advantages: Percentage values enable comparison of model performance relative to benchmarks, making it easier to understand performance in context. Organizations can adjust percentage thresholds to be more or less sensitive to performance changes based on operational requirements. Benchmark Flexibility: Different benchmark types (theoretical maximum, historical baseline, industry standard) can be used depending on organizational preferences. Intuitive Interpretation: Percentage values are intuitive for stakeholders to understand, facilitating communication about model performance status.

The percentage-based threshold mechanism directly supports the technical effect of reducing latency in detecting model performance degradation. By automatically comparing computed percentage values against configured percentage thresholds, the system eliminates delays associated with manual review processes and enables immediate identification of models exhibiting degraded performance. The automated generation of performance degradation signals when percentage values fall below percentage thresholds ensures that organizations receive timely notification of performance issues, enabling faster remediation and minimizing periods of suboptimal automation performance.

In an embodiment, the system may compare the combined model score against one or more prior combined model scores from prior evaluation periods to detect a declining performance trend. The system may generate the performance degradation signal when a difference between the combined model score and the one or more prior combined model scores exceeds a configurable drift threshold.

In some cases, the system may detect performance degradation by comparing the combined model score against one or more prior combined model scores from prior evaluation periods to detect a declining performance trend. The system may generate the performance degradation signal when a difference between the combined model score and the one or more prior combined model scores exceeds a configurable drift threshold. The drift detection capability enables the system to identify gradual performance degradation that may not trigger absolute threshold violations but nonetheless indicates declining model quality over time. This approach addresses scenarios where a deployed AI model's performance degrades gradually over time rather than experiencing a sudden drop below an absolute threshold. A model may decline from a score of 90 to 85 to 80 to 75 across successive evaluation periods, with each individual score remaining above an absolute threshold of 70, yet the cumulative decline indicates significant performance degradation that warrants attention.

In an embodiment, prior combined model scores represent the combined model scores computed during previous evaluation periods. The system maintains a historical record of combined model scores for each deployed AI model, enabling comparison between current performance and historical performance. The prior evaluation periods may correspond to:
Previous days, weeks, or months of model operation
Previous batches of automation task executions
Previous cycles of the continuous evaluation process. The drift threshold represents a configurable boundary that defines the maximum acceptable difference between current and prior combined model scores. Organizations may configure drift thresholds based on their tolerance for performance variation and their operational requirements. For example, an organization may configure a drift threshold of 10 points, meaning that if the current combined model score differs from prior scores by more than 10 points, the system generates a performance degradation signal.

The system compares the current combined model score against prior combined model scores using one or more comparison approaches: The system compares the current combined model score against the combined model score from the immediately preceding evaluation period. If the difference exceeds the drift threshold, the system generates a performance degradation signal. The system compares the current combined model score against combined model scores from multiple prior evaluation periods. The system may compute an average of prior scores and compare the current score against the average. Alternatively, the system may compare the current score against each prior score individually and generate a performance degradation signal if the difference exceeds the drift threshold for any comparison. The system compares the current combined model score against a baseline score established during an initial evaluation period, such as the model's first month of deployment. This approach detects cumulative drift from the model's original performance level.

### Example: Drift-Based Degradation Detection

Consider a deployed AI model used for document classification automation. The organization has configured a drift threshold of 10 points.

| Evaluation | Combined | Change from | Cumulative Change |
|---|---|---|---|
| Period | Model Score | Prior Period | from Period 1 |
| Period 1 | 88 | — | — |
| Period 2 | 85 | −3 | −3 |
| Period 3 | 82 | −3 | −6 |
| Period 4 | 79 | −3 | −9 |
| Period 5 | 76 | −3 | −12 |

### Analysis:

No single period-to-period change exceeds the drift threshold of 10 points
However, the cumulative change from Period 1 to Period 5 is 12 points (88 to 76), which exceeds the drift threshold
The system detects a declining performance trend and generates a performance degradation signal

If the organization had configured only an absolute threshold of 75, the model would not trigger a performance degradation signal until Period 5 or later when the score falls below 75. The drift-based detection identifies the degradation earlier by recognizing the cumulative decline pattern.

In an embodiment, detecting the declining performance trend may comprise computing confidence intervals around historical combined model scores and classifying a performance change as model drift when the combined model score falls outside the computed confidence intervals. Detecting the declining performance trend may comprise computing confidence intervals around historical combined model scores and classifying a performance change as model drift when the combined model score falls outside the computed confidence intervals. The system computes confidence intervals around historical combined model scores to establish a statistical boundary representing normal performance variation. The confidence interval defines a range within which combined model scores are expected to fall under normal operating conditions.

The confidence interval computation may involve: The system collects combined model scores from multiple prior evaluation periods to establish a historical dataset. The number of prior periods used may be configurable, such as the most recent 10, 20, or 30 evaluation periods.

Step 2: Computing Statistical Parameters: The system computes statistical parameters from the historical dataset, including:
Mean (average) of historical combined model scores
   Standard deviation measuring the spread of historical scores around the mean. Step 3: Establishing Confidence Interval Boundaries: The system establishes confidence interval boundaries based on the computed statistical parameters. Common confidence interval configurations include:
95% confidence interval: Mean±1.96× Standard Deviation
99% confidence interval: Mean±2.58× Standard Deviation
90% confidence interval: Mean±1.645× Standard Deviation

The confidence level may be configurable based on organizational preferences for sensitivity to performance changes.

The system classifies a performance change as model drift when the current combined model score falls outside the computed confidence intervals. When the current score falls below the lower boundary of the confidence interval, the system determines that the model is performing significantly worse than its historical norm and generates a performance degradation signal.

### Example: Confidence Interval-Based Drift Detection

Consider a deployed AI model with the following historical combined model scores from the past 10 evaluation periods:

| Period | Combined Model Score |
|---|---|
| 1 | 85 |
| 2 | 87 |
| 3 | 84 |
| 4 | 86 |
| 5 | 88 |
| 6 | 85 |
| 7 | 86 |
| 8 | 84 |
| 9 | 87 |
| 10 | 83 |

### Step 1: Compute Statistical Parameters

Mean: (85+87+84+86+88+85+86+84+87+83)/10=85.5
Standard Deviation: approximately 1.58

### Step 2: Establish 95% Confidence Interval

Lower Boundary: 85.5−(1.96×1.58)=85.5−3.10=82.4

Upper Boundary: 85.5+(1.96×1.58)=85.5+3.10=88.6
95% Confidence Interval: [82.4, 88.6]

### Step 3: Evaluate Current Score

Scenario A: Current combined model score=84
Score 84 falls within the confidence interval [82.4, 88.6]
Result: No model drift detected; performance is within normal variation

Scenario B: Current combined model score=80
Score 80 falls below the lower boundary of 82.4
Result: Model drift detected; performance change classified as statistically significant
System generates performance degradation signal

Scenario C: Current combined model score=78
Score 78 falls significantly below the lower boundary of 82.4
Result: Model drift detected with high confidence; performance degradation is severe
System generates performance degradation signal and may prioritize the recommendation for model transition

In an embodiment, the system is configured to collect user feedback on responses generated by the deployed artificial intelligence model through a rating interface that presents thumbs up and thumbs down feedback options. The system associates each user feedback submission with metadata including an identifier for the deployed artificial intelligence model, a timestamp, and a categorization of a task type that prompted the response. The system incorporates the user feedback into the numerical scores to inform the combined model score. The system may collect user feedback on responses generated by the deployed artificial intelligence model through a rating interface that presents thumbs up and thumbs down feedback options. The rating interface may be presented to users within the automation environment after the deployed AI model generates a response. In some cases, the rating interface may appear as a visual component adjacent to the model's output, enabling users to provide immediate feedback on the quality, accuracy, or usefulness of the response.

In an embodiment, the system may associate each user feedback submission with metadata including an identifier for the deployed artificial intelligence model, a timestamp, and a categorization of a task type that prompted the response. The metadata association enables the system to track feedback at a granular level, supporting analysis of model performance across different contexts. The metadata components include: Model Identifier: A unique reference to the specific AI model that generated the response, enabling the system to attribute feedback to the correct model when multiple models are deployed. Timestamp: The date and time when the feedback was submitted, enabling temporal analysis of model performance and detection of performance changes over time. Task Type Categorization: A classification of the automation task that prompted the model response, enabling analysis of model performance across different task categories such as document extraction, report generation, or data reconciliation. Incorporating Feedback into Numerical Scores: The system may incorporate the user feedback into the numerical scores to inform the combined model score. The feedback collection mechanism may compute feedback ratios expressing a proportion of positive feedback relative to total feedback received for each deployed model by dividing a count of thumbs up submissions by a sum of thumbs up and thumbs down submissions, and may incorporate the feedback ratios into the combined model scores.

### Example: User Feedback Integration

Consider a deployed AI model used for invoice data extraction. Over a one-week evaluation period, the system collects the following user feedback:

| Day | Thumbs Up | Thumbs Down | Daily Feedback Ratio |
|---|---|---|---|
| Monday | 45 | 5 | 90% |
| Tuesday | 42 | 8 | 84% |
| Wednesday | 38 | 12 | 76% |
| Thursday | 35 | 15 | 70% |
| Friday | 30 | 20 | 60% |

### Weekly Aggregate:

Total thumbs up: 190
Total thumbs down: 60
Feedback ratio: 190/(190+60)=76%

The system incorporates the 76% feedback ratio into the numerical scores. If the feedback factor has a configured weight of 0.20 in the combined model score calculation, the feedback contribution would be: Feedback contribution=76×0.20=15.2 points. The declining daily feedback ratios (from 90% to 60%) may also trigger drift detection mechanisms, potentially generating a performance degradation signal even if the weekly aggregate remains above threshold criteria.

The system is configured to configure the importance levels for the evaluation factors using slider interfaces that enable specification of importance levels from one to ten for each evaluation factor. The evaluation factors include output consistency, governance, compliance, and cost. In some cases, the system may configure the importance levels for the evaluation factors using slider interfaces that enable specification of importance levels from one to ten for each evaluation factor. The evaluation factors may include output consistency, governance, compliance, and cost. The slider interfaces provide a visual mechanism for customers to specify the relative importance of each evaluation factor. Each slider may be presented as a horizontal control that users can adjust by dragging a handle along a scale from one (lowest importance) to ten (highest importance).

The system supports configuration of importance levels for the following evaluation factors: Output Consistency: Measures the degree to which the deployed AI model produces consistent outputs for similar inputs across multiple invocations. Higher importance levels for output consistency prioritize models that exhibit predictable behavior. Governance: Measures adherence to organizational policies, approval workflows, and oversight requirements. Higher importance levels for governance prioritize models that operate within established governance frameworks. Compliance: Measures adherence to regulatory requirements, industry standards, and audit requirements. Higher importance levels for compliance prioritize models that satisfy regulatory obligations.

Cost: Measures the computational and financial resources consumed by the deployed AI model during inference operations. Higher importance levels for cost prioritize models that achieve acceptable performance with lower resource consumption.

When a customer adjusts an importance level for an evaluation factor, the system may store the configured importance level in association with the customer's organizational profile and may use the configured importance levels to weight evaluation scores when generating aggregate model rankings.

### Example: User Interface Configuration for Financial Services Organization

A financial services organization configures the following importance levels using the user interfaces:

| Evaluation Factor | Slider Position (1-10) |
|---|---|
| Output Consistency | 7 |
| Governance | 8 |
| Compliance | 10 |
| Cost | 4 |

The system normalizes these importance levels to weighting factors:
Total = 7 + 8 + 10 + 4 = 29

| Evaluation Factor | Normalized Weight |
|---|---|
| Output Consistency | 7/29 = 0.24 |
| Governance | 8/29 = 0.28 |
| Compliance | 10/29 = 0.34 |
| Cost | 4/29 = 0.14 |

When the domain-trained model produces numerical scores for the deployed AI model, the scoring module applies these weights:

| Evaluation Factor | Numerical Score | Weight | Weighted Score |
|---|---|---|---|
| Output Consistency | 85 | 0.24 | 20.4 |
| Governance | 82 | 0.28 | 22.96 |
| Compliance | 90 | 0.34 | 30.6 |
| Cost | 75 | 0.14 | 10.5 |

Combined Model Score=20.4+22.96+30.6+10.5=84.46

Because the organization weighted compliance heavily (slider position 10) and the model scored well on compliance (90), the combined score reflects this alignment with organizational priorities. The system is configured to generate a heat map representing performance of the deployed artificial intelligence model across the evaluation factors. Generating the heat map comprises organizing the numerical scores into a matrix structure where rows correspond to evaluation periods and columns correspond to the evaluation factors, and applying a color mapping function to transform the numerical scores into corresponding color values within a defined gradient range.

In an embodiment, the system may generate a heat map representing performance of the deployed artificial intelligence model across the evaluation factors. Generating the heat map may comprise organizing the numerical scores into a matrix structure where rows correspond to evaluation periods and columns correspond to the evaluation factors, and applying a color mapping function to transform the numerical scores into corresponding color values within a defined gradient range. The system organizes numerical scores into a two-dimensional matrix structure: Rows: Each row corresponds to an evaluation period, such as a day, week, or month. The rows are ordered chronologically to enable visualization of performance trends over time. Columns: Each column corresponds to an evaluation factor, such as compliance factors, quality factors, responsible AI parameters, output consistency, governance, or cost. The columns enable comparison of performance across different evaluation dimensions. Color Mapping Function

The system applies a color mapping function to transform numerical scores into visual color representations. The color mapping function may use a gradient range that visually distinguishes high-performing scores from low-performing scores. For example, the system may apply a gradient from green (high scores) through yellow (medium scores) to red (low scores):
Scores 80-100: Green shades (darker green for higher scores)
Scores 60-79: Yellow shades
Scores 0-59: Red shades (darker red for lower scores)

The heat map visualization may enable identification of model strengths and weaknesses across multiple criteria dimensions and may inform qualitative recommendations regarding model deployment decisions.

### Example: Heat Map for Invoice Processing Model

Consider a deployed AI model evaluated over four weeks across four evaluation factors:

| Week | Compliance | Quality | Responsible AI | Cost |
|---|---|---|---|---|
| Week 1 | 92 | 88 | 85 | 78 |
| Week 2 | 90 | 85 | 82 | 75 |
| Week 3 | 85 | 78 | 80 | 72 |
| Week 4 | 78 | 72 | 76 | 70 |

The system applies the color mapping function to generate a heat map:

| Week | Compliance | Quality | Responsible AI | Cost |
|---|---|---|---|---|
| Week 1 | Dark Green | Green | Green | Yellow |
| Week 2 | Green | Green | Green | Yellow |
| Week 3 | Green | Yellow | Green | Yellow |
| Week 4 | Yellow | Yellow | Yellow | Yellow |

The heat map visualization reveals:

Declining trend: All evaluation factors show declining scores from Week 1 to Week 4
Relative strength: Compliance and Responsible AI maintain higher scores (green) longer than Quality and Cost
Emerging concern: Quality factor transitions from green to yellow between Week 2 and Week 3, indicating potential degradation in task completion effectiveness

The heat map enables administrators to quickly identify patterns that may warrant investigation or model transition recommendations.

The system is configured to perform offline evaluation using a golden test data set, wherein each test case within the golden test data set includes an input specification, an expected output specification, and a predetermined rating. Performing offline evaluation comprises submitting each test case input to the deployed artificial intelligence model, capturing a model response for each test case input, comparing each captured model response against the corresponding expected output specification, and incorporating the predetermined rating into the combined model score when the model response matches the expected output specification within defined tolerance parameters.

In some cases, the system may perform offline evaluation using a golden test data set, wherein each test case within the golden test data set includes an input specification, an expected output specification, and a predetermined rating. The golden test data set represents a curated collection of test cases that serve as benchmarks for evaluating model performance. Each test case contains three components: Input Specification: The input data or prompt that will be submitted to the deployed AI model. The input specification may include text prompts, document samples, data records, or other artifacts that represent typical inputs encountered during automation task execution. Expected Output Specification: The correct or ideal output that the deployed AI model should produce for the given input. The expected output specification serves as a reference against which actual model responses are compared. Predetermined Rating: A quality score assigned to the test case that will be incorporated into the combined model score when the model produces a matching response. The predetermined rating reflects the importance or difficulty of the test case. Offline Evaluation Process: Performing offline evaluation may comprise submitting each test case input to the deployed artificial intelligence model, capturing a model response for each test case input, comparing each captured model response against the corresponding expected output specification, and incorporating the predetermined rating into the combined model score when the model response matches the expected output specification within defined tolerance parameters.

The offline evaluation process operates as follows: The system iterates through the golden test data set and submits each test case input to the deployed AI model. The submission may occur in batch mode during off-peak computing cycles to minimize impact on production workloads. Step 2: Capture Model Responses: The system captures the response generated by the deployed AI model for each test case input. The captured responses are stored for subsequent comparison against expected output specifications. Step 3: Compare Against Expected Outputs: The system compares each captured model response against the corresponding expected output specification. The comparison may use exact matching, fuzzy matching, semantic similarity, or other comparison methods depending on the nature of the outputs. Step 4: Incorporate Predetermined Ratings: When a model response matches the expected output specification within defined tolerance parameters, the system incorporates the predetermined rating into the combined model score. The tolerance parameters define acceptable variation between actual and expected outputs. Proactive Assessment Capability: The offline evaluation capability may enable proactive assessment of models before deployment to customers, allowing the system to generate preliminary performance assessments that indicate how models perform relative to evaluation criteria represented in the golden test data sets.

### Example: Offline Evaluation for Document Classification Model

Consider a golden test data set containing 100 test cases for a document classification model:

| Test | | | Predetermined |
|---|---|---|---|
| Case ID | Input Specification | Expected Output | Rating |
| TC-001 | Invoice document | Category: | 5 |
| | sample | Invoice | |
| TC-002 | Purchase order | Category: | 5 |
| | sample | Purchase Order | |
| TC-003 | Contract document | Category: | 8 |
| | sample | Contract | |
| TC-004 | Ambiguous | Category: Other | 10 |
| | document sample | | |
| . . . | . . . | . . . | . . . |

The system performs offline evaluation:
1. Submit: System submits each document sample to the deployed AI model
2. Capture: System captures the classification result for each document
3. Compare: System compares each classification result against the expected category
4. Incorporate: System incorporates predetermined ratings for matching results

### Results:

85 test cases: Model response matches expected output (within tolerance)
15 test cases: Model response does not match expected output

### Score Calculation:

Total predetermined ratings for matching cases: 425 points
Maximum possible predetermined ratings: 500 points
Offline evaluation score: 425/500=85%

The 85% offline evaluation score is incorporated into the combined model score calculation, providing an objective benchmark-based assessment that complements real-time evaluation factors.

The system is configured such that the recommendation to transition to the alternative artificial intelligence model includes an identifier of the alternative artificial intelligence model and a performance comparison indicating that the alternative artificial intelligence model achieves a higher combined model score than the deployed artificial intelligence model. The recommendation to transition to the alternative artificial intelligence model may include an identifier of the alternative artificial intelligence model and a performance comparison indicating that the alternative artificial intelligence model achieves a higher combined model score than the deployed artificial intelligence model. The recommendation transmitted by the system contains structured information that enables informed decision-making regarding model transitions: Alternative Model Identifier: A unique reference to the specific AI model being recommended as a replacement. The identifier may include the model name, version number, provider information, and deployment location. Performance Comparison: Quantitative data showing how the alternative model's combined model score compares to the deployed model's score. The performance comparison provides evidence supporting the recommendation. Candidate Model Identification: The system may identify candidate replacement models by querying a model performance repository for models that achieve higher performance scores than the degrading model across the evaluation criteria where degradation was detected. The recommendations may include supporting evidence derived from the scoring processes, such as aggregate score values, factor-specific score comparisons, and trend indicators showing performance trajectories. Supporting Evidence: The recommendation includes supporting evidence that enables administrators to evaluate the recommendation: Aggregate Score Values: The combined model scores for both the deployed model and the alternative model, enabling direct numerical comparison. Factor-Specific Score Comparisons: Numerical scores for each evaluation factor, showing where the alternative model outperforms the deployed model and where performance is comparable. Trend Indicators: Historical performance data showing performance trajectories for both models, enabling assessment of whether the alternative model exhibits stable or improving performance.

### Example: Recommendation with Performance Comparison

Consider a scenario where the system detects performance degradation in a deployed AI model and generates a recommendation:

### Performance Degradation Detection:

Deployed model: Invoice Processor v2.1
Current combined model score: 68
Threshold criterion: 75
Result: Performance degradation signal generated

### Candidate Model Identification:

The system queries the model performance repository and identifies an alternative model:
Alternative model: Invoice Processor v3.0
Combined model score: 87

### Recommendation Content:

RECOMMENDATION: Transition to Alternative Model
Deployed Model: Invoice Processor v2.1
Alternative Model: Invoice Processor v3.0
Trend Analysis:
   Deployed model: Declining trend over past 4 weeks (82→68)
   Alternative model: Stable performance over past 4 weeks (85→87)
Recommendation Confidence: High
Basis: Alternative model exceeds deployed model by 19 points across all evaluation factors

The recommendation provides administrators with comprehensive information to make an informed decision about transitioning to the alternative model, including the specific identifier of the recommended model and quantitative evidence demonstrating superior performance.

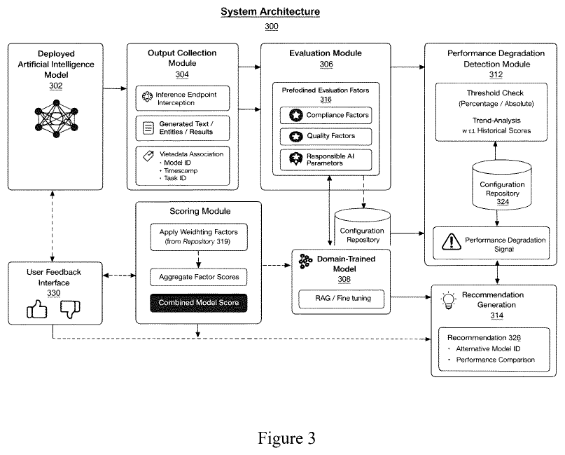

Referring now to FIG. 3, a block diagram 300 illustrating a system architecture for evaluating performance of a deployed artificial intelligence model to reduce latency in detecting model performance degradation is shown. The system architecture 300 includes a deployed artificial intelligence model 302, an output collection module 304, an evaluation module 306, a domain-trained model 308, a scoring module 310, a performance degradation detection module 312, and a recommendation generation module 314.

In an embodiment, the deployed artificial intelligence model 302 generates outputs during execution of one or more automation tasks by bots and automated workflows. The deployed artificial intelligence model 302 may be a large language model or other AI model configured to perform domain-specific tasks such as document extraction, report generation, customer inquiry handling, or data reconciliation.

In an embodiment, the output collection module 304 is configured to obtain output generated by the deployed artificial intelligence model 302. The output collection module 304 may intercept model outputs at inference endpoints where bots and workflows invoke the deployed artificial intelligence model 302. The output collection module 304 may capture output data including generated text, extracted entities, classification results, and other artifacts produced during task execution. The output collection module 304 may associate obtained outputs with metadata including model identifiers, timestamps, and automation task identifiers.

In an embodiment, the evaluation module 306 is configured to evaluate the obtained output against one or more predefined evaluation factors 316. The predefined evaluation factors 316 comprise compliance factors 316a indicating adherence to defined requirements, quality factors 316b indicating effectiveness in completing automation tasks, and responsible artificial intelligence parameters 316c indicating adherence to operational constraints. In some cases, the predefined evaluation factors 316 may include additional niche business attributes such as green supply chain management factors or leadership diversity metrics. The evaluation module 306 may receive customer-defined evaluation factors from a configuration repository 318 that stores factor definitions, scoring criteria, and importance levels in association with customer organizational profiles.

In an embodiment, the domain-trained model 308 is configured to score the obtained output to generate numerical scores representing output quality across each evaluation factor. The domain-trained model 308 processes the predefined evaluation factors 316 to produce the numerical scores. The domain-trained model 308 may be trained using Retrieval Augmented Generation (RAG) on robotic process automation-specific entities, wherein a knowledge base 320 contains definitions and operational characteristics of enterprise application identifiers, bot name registries, action type definitions, trigger type specifications, and credential reference patterns. Alternatively, the domain-trained model 308 may be trained using fine-tuning on domain-specific datasets.

In an embodiment, the scoring module 310 is configured to compute a combined model score that aggregates the numerical scores across the evaluation factors by applying weighting factors corresponding to configured importance levels for each evaluation factor. The scoring module 310 may receive importance levels from the configuration repository 318 and may multiply each individual factor score by the corresponding weight to compute weighted sums representing aggregate performance assessments. The scoring module 310 may output the combined model score to the performance degradation detection module 312.

In an embodiment, the performance degradation detection module 312 is configured to generate a performance degradation signal 322 for the deployed artificial intelligence model 302 when the combined model score falls below a threshold criterion. The threshold criterion may be stored in the configuration repository 318 and may comprise a percentage threshold or an absolute score value. The performance degradation detection module 312 may also compare the combined model score against prior combined model scores from a historical score repository 324 to detect declining performance trends. The performance degradation detection module 312 may compute confidence intervals around historical combined model scores and may classify a performance change as model drift when the combined model score falls outside the computed confidence intervals.

In an embodiment, the recommendation generation module 314 is configured to transmit a recommendation 326 to transition to an alternative artificial intelligence model in response to the performance degradation signal 322. The recommendation generation module 314 may query a model performance repository 328 to identify candidate replacement models that achieve higher combined model scores than the deployed artificial intelligence model 302. The recommendation 326 may include an identifier of the alternative artificial intelligence model and a performance comparison indicating that the alternative model achieves a higher combined model score than the deployed model.

In an embodiment, the system architecture 300 may include a user feedback interface 330 configured to collect user feedback on responses generated by the deployed artificial intelligence model 302. The user feedback interface 330 may present thumbs up and thumbs down feedback options and may associate each feedback submission with metadata including model identifiers, timestamps, and task type categorizations. The user feedback may be incorporated into the numerical scores by the scoring module 310 to inform the combined model score.

In an embodiment, the system architecture 300 may include a visualization module 332 configured to generate heat maps representing performance of the deployed artificial intelligence model 302 across the evaluation factors. The visualization module 332 may organize numerical scores into a matrix structure where rows correspond to evaluation periods and columns correspond to evaluation factors, and may apply color mapping functions to transform numerical scores into corresponding color values within a defined gradient range.

Conventional model evaluation approaches rely on generic performance metrics such as accuracy, perplexity, and throughput, which do not capture domain-specific evaluation factors required for deployment in constrained environments. The disclosed system addresses this limitation by utilizing domain-trained models configured to score outputs against domain-specific criteria. The system extracts evaluation factors including compliance indicators, quality indicators, and responsible artificial intelligence parameters, and generates corresponding scores using the domain-trained models. Different domain-trained models may be configured for different domains, such that a model configured for financial environments emphasizes numerical accuracy and regulatory adherence, while a model configured for supply chain environments emphasizes timeliness and coordination effectiveness. This multi-dimensional evaluation framework enables assessment of model performance beyond generic metrics. Existing evaluation frameworks do not provide mechanisms to configure relative importance across evaluation factors. The disclosed system introduces a parameter configuration interface that enables assignment of importance levels to evaluation factors. The importance levels are stored and applied as weighting factors during score aggregation. A scoring module generates combined model scores by applying the weighting factors to individual factor scores and computing weighted aggregates. This configurable weighting mechanism enables alignment of evaluation outputs with operational priorities by modifying the contribution of each evaluation factor in the aggregated score.

Determining when to transition between models is typically performed using manual analysis, resulting in delayed or suboptimal decisions. The disclosed system automates model lifecycle management by generating performance degradation signals when combined model scores fall below defined threshold criteria. In response, the system identifies candidate replacement models from a model performance repository and generates transition outputs based on comparative score analysis. The transition outputs include identifiers of alternative models and associated performance differentials, enabling automated and data-driven model replacement. Delayed detection of model performance degradation can result in extended operation of underperforming models. The disclosed system reduces detection latency by continuously monitoring outputs generated during execution of automated processes, extracting evaluation factors, and updating model scores in real time. Performance degradation signals are generated upon detecting threshold violations. In some implementations, degradation detection includes comparison of current combined scores with historical scores to identify declining performance trends, including detection of score deviations exceeding a configurable drift threshold. This continuous evaluation mechanism reduces the delay between performance degradation and detection.

Feedback systems in conventional deployments operate independently of model evaluation pipelines and are not incorporated into scoring mechanisms. The disclosed system integrates feedback signals into the scoring pipeline by associating feedback inputs with model outputs and corresponding metadata, including model identifiers and execution context. The system computes feedback-derived metrics and incorporates the metrics into combined model scores. This integration establishes a continuous feedback loop in which operational feedback contributes directly to model evaluation and ranking. Performance drift in deployed models is often detected through manual processes. The disclosed system implements automated drift detection by analyzing temporal variations in combined model scores. Drift detection may include comparing current scores with historical score distributions and identifying deviations outside defined confidence intervals. This enables identification of gradual performance degradation that may not trigger threshold-based alerts, thereby enabling proactive detection of model degradation.

Evaluating models across multiple parameters using full inference pipelines introduces computational overhead and latency. The disclosed system reduces computational load by employing domain-trained models for parameter-specific scoring and aggregating the resulting scores. In some implementations, the domain-trained models are configured using Retrieval Augmented Generation (RAG), enabling incorporation of domain knowledge through a knowledge base without modifying model weights. This architecture reduces reliance on repeated full-model inference and supports scalable evaluation across multiple parameters. The disclosed system enables end-to-end automated evaluation of models without manual intervention. The system processes outputs generated by deployed models, extracts evaluation factors, generates scores, aggregates scores, detects performance degradation, and produces transition outputs. This automated pipeline enables continuous evaluation and reduces latency and variability associated with manual processes.

The system reduces processing latency in model evaluation by performing continuous output monitoring and real-time scoring. Evaluation data is captured during execution of automated processes, and scores are generated without requiring batch processing. Threshold-based comparisons are performed continuously to generate degradation signals upon detection of performance changes. This enables rapid response to model performance variations. The system improves accuracy of model selection through multi-factor evaluation. The use of multiple evaluation factor categories, including compliance, quality, and responsible artificial intelligence parameters, enables comprehensive assessment of model performance. Weighted aggregation of factor scores allows prioritization of specific evaluation dimensions. Integration of feedback signals further refines scoring by incorporating operational performance data. This multi-factor evaluation produces more precise model ranking and selection outcomes compared to single-metric approaches.

A number of implementations have been described. Nevertheless, it will be understood that various modifications may be made without departing from the spirit and scope of the disclosure. Accordingly, other implementations are within the scope of the following claims.

1. A computer-implemented method for evaluating performance of a deployed artificial intelligence model to reduce latency in detecting model performance degradation, the method comprising:
obtaining, by one or more processors, output generated by the deployed artificial intelligence model during execution of one or more automation tasks by bots and automated workflows;
evaluating, by the one or more processors, the output against one or more predefined evaluation factors, wherein the evaluation factors comprise compliance factors indicating adherence to defined requirements, quality factors indicating effectiveness in completing one or more automation tasks, and responsible artificial intelligence parameters indicating adherence to operational constraints, where in the evaluation comprises;
scoring, by the one or more processors, the obtained output using a domain-trained model to generate numerical scores representing output quality across each evaluation factor, wherein the domain-trained model processes the predefined evaluation factors to produce the numerical scores;
computing, by the one or more processors, a combined model score that aggregates the numerical scores across the evaluation factors by applying weighting factors corresponding to configured importance levels for each evaluation factor;
generating, by the one or more processors, a performance degradation signal for the deployed artificial intelligence model when the combined model score falls below a threshold criterion, wherein the performance degradation signal enables automated detection of the model performance degradation without manual evaluation, thereby reducing the latency in detecting the model performance degradation; and
transmitting, by the one or more processors, a recommendation to transition to an alternative artificial intelligence model in response to the performance degradation signal.

2. The method of claim 1, further comprising training the domain-trained model using Retrieval Augmented Generation on robotic process automation-specific entities, wherein the robotic process automation-specific entities include enterprise application identifiers, bot name registries, action type definitions, trigger type specifications, and credential reference patterns.

3. The method of claim 2, wherein training the domain-trained model using Retrieval Augmented Generation comprises:
constructing a knowledge base comprising definitions and operational characteristics of the robotic process automation-specific entities;
retrieving relevant entity definitions from the knowledge base based on entities identified within an evaluation request context; and
incorporating the retrieved entity definitions into a prompt provided to the domain-trained model to augment context with domain-specific information that informs scoring decisions.

4. The method of claim 1, wherein the threshold criterion comprises a percentage threshold, and wherein the method further comprises:
computing the combined model score as a percentage value representing model performance relative to a defined benchmark; and
generating the performance degradation signal when the percentage value falls below the percentage threshold.

5. The method of claim 1, further comprising:
comparing the combined model score against one or more prior combined model scores from prior evaluation periods to detect a declining performance trend; and
generating the performance degradation signal when a difference between the combined model score and the one or more prior combined model scores exceeds a configurable drift threshold.

6. The method of claim 5, wherein detecting the declining performance trend comprises:
computing confidence intervals around historical combined model scores; and
classifying a performance change as model drift when the combined model score falls outside the computed confidence intervals.

7. The method of claim 1, further comprising:
collecting user feedback on responses generated by the deployed artificial intelligence model through a rating interface that presents thumbs up and thumbs down feedback options;
associating each user feedback submission with metadata including an identifier for the deployed artificial intelligence model, a timestamp, and a categorization of a task type that prompted the response; and
incorporating the user feedback into the numerical scores to inform the combined model score.

8. The method of claim 1, further comprising configuring the importance levels for the evaluation factors using slider interfaces that enable specification of importance levels from one to ten for each evaluation factor, wherein the evaluation factors include output consistency, governance, compliance, and cost.

9. The method of claim 1, further comprising performing offline evaluation using a test data set, wherein each test case within the test data set includes an input specification, an expected output specification, and a predetermined rating, and wherein performing offline evaluation comprises:
submitting each test case input to the deployed artificial intelligence model;
capturing a model response for each test case input;
comparing each captured model response against the corresponding expected output specification; and
incorporating the predetermined rating into the combined model score when the model response matches the expected output specification within defined tolerance parameters.

10. The method of claim 1, wherein the method further comprises:
continuously monitoring the outputs generated by the deployed artificial intelligence model during execution of automation tasks

11. A system for evaluating performance of a deployed artificial intelligence model to reduce latency in detecting model performance degradation, the system comprising:
at least one memory storing one or more instructions; and
at least one processor that, upon execution of the one or more instructions, is configured to:
obtain output generated by the deployed artificial intelligence model during execution of one or more automation tasks by bots and automated workflows;
evaluate the output against one or more predefined evaluation factors, wherein the evaluation factors comprise compliance factors indicating adherence to defined requirements, quality factors indicating effectiveness in completing one or more automation tasks, and responsible artificial intelligence parameters indicating adherence to operational constraints, wherein the evaluation comprises:
scoring the obtained output using a domain-trained model to generate numerical scores representing output quality across each evaluation factor, wherein the domain-trained model processes the predefined evaluation factors to produce the numerical scores;
compute a combined model score that aggregates the numerical scores across the evaluation factors by applying weighting factors corresponding to configured importance levels for each evaluation factor;
generate a performance degradation signal for the deployed artificial intelligence model when the combined model score falls below a threshold criterion, wherein the performance degradation signal enables automated detection of the model performance degradation without manual evaluation, thereby reducing the latency in detecting the model performance degradation; and
transmit a recommendation to transition to an alternative artificial intelligence model in response to the performance degradation signal.

12. The system of claim 11, wherein the at least one processor is further configured to train the domain-trained model using Retrieval Augmented Generation on robotic process automation-specific entities, wherein the robotic process automation-specific entities include enterprise application identifiers, bot name registries, action type definitions, trigger type specifications, and credential reference patterns.

13. The system of claim 12, wherein training the domain-trained model using Retrieval Augmented Generation comprises:
constructing a knowledge base comprising definitions and operational characteristics of the robotic process automation-specific entities;
retrieving relevant entity definitions from the knowledge base based on entities identified within an evaluation request context; and
incorporating the retrieved entity definitions into a prompt provided to the domain-trained model to augment context with domain-specific information that informs scoring decisions.

14. The system of claim 11, wherein the threshold criterion comprises a percentage threshold, and wherein the at least one processor is further configured to:
compute the combined model score as a percentage value representing model performance relative to a defined benchmark; and
generate the performance degradation signal when the percentage value falls below the percentage threshold.

15. The system of claim 11, wherein the at least one processor is further configured to:
compare the combined model score against one or more prior combined model scores from prior evaluation periods to detect a declining performance trend; and
generate the performance degradation signal when a difference between the combined model score and the one or more prior combined model scores exceeds a configurable drift threshold.

16. The system of claim 15, wherein detecting the declining performance trend comprises:
computing confidence intervals around historical combined model scores; and
classifying a performance change as model drift when the combined model score falls outside the computed confidence intervals.

17. The system of claim 11, wherein the at least one processor is further configured to:
collect user feedback on responses generated by the deployed artificial intelligence model through a rating interface that presents thumbs up and thumbs down feedback options;
associate each user feedback submission with metadata including an identifier for the deployed artificial intelligence model, a timestamp, and a categorization of a task type that prompted the response; and
incorporate the user feedback into the numerical scores to inform the combined model score.

18. The system of claim 11, wherein the at least one processor is further configured to configure the importance levels for the evaluation factors using slider interfaces that enable specification of importance levels from one to ten for each evaluation factor, wherein the evaluation factors include output consistency, governance, compliance, and cost.

19. The system of claim 11, wherein the at least one processor is further configured to perform offline evaluation using a test data set, wherein each test case within the test data set includes an input specification, an expected output specification, and a predetermined rating, and wherein performing offline evaluation comprises:
submitting each test case input to the deployed artificial intelligence model;
capturing a model response for each test case input;
comparing each captured model response against the corresponding expected output specification; and
incorporating the predetermined rating into the combined model score when the model response matches the expected output specification within defined tolerance parameters.

20. The system of claim 11, wherein the recommendation to transition to the alternative artificial intelligence model includes an identifier of the alternative artificial intelligence model and a performance comparison indicating that the alternative artificial intelligence model achieves a higher combined model score than the deployed artificial intelligence model.
